(19) United States
(12) Patent Application Publication
(10) Pub. No.: US 2011/0090577 A1
(43) Pub. Date: Apr. 21, 2011

(54) OPTICAL SYSTEM COMPRISING A DEVICE FOR DISPLAYING INFORMATION RELATIVE TO THE IMPLEMENTATION OF AN AUTOMOBILE ACCESSORY

(75) Inventors: Maryline Thorailler, Ormesson sur Marne (FR); Pierre Louis Tassy, Asnieress sur Seine (FR)

(73) Assignee: VALEO SYSTEMES THERMIQUES, Le Mesnil Saint Denis Cedex (FR)

(21) Appl. No.: 12/808,759

(22) PCT Filed: Dec. 16, 2008
(86) PCT No.: PCT/EP2008/067675

§ 371 Date: Dec. 22, 2010

(30) Foreign Application Priority Data
Dec. 18, 2007 (FR) 07/08807

(51) Int. Cl. G02B 9/60; G02B 9/34

(52) U.S. Cl. 359/763; 359/771

(57) ABSTRACT

The invention relates to an optical system (10) that comprises a plurality of lenses (12) distributed into a first group (13) including at least two lenses (12) and a second group (14) including at least two lenses (12), wherein at least one lens (12) of the first group (13) is provided over a corresponding lens (12) of the second group (14). The optical system (10) is provided with a means (20) for guiding the light rays (11) entering inside any lens (12) of the first group (13) towards the corresponding lens (12) of the second group (14).

### TECHNICAL FIELD OF THE INVENTION

The present invention is from the field of information display devices relating to the implementation of an automobile accessory, such as a ventilation, heating and/or air conditioning installation. Its object is an optical system pertaining to such a display device and said display device.

### STATE OF THE ART

An automobile is commonly equipped with an accessory, such as a ventilation, heating and/or air conditioning installation for the air contained within the vehicle's passenger compartment, a portable telephone, an onboard computer, a satellite locating system or other similar accessory. The accessory can be almost any equipment, such as an optional appliance which is not essential to a primary and critical function of the vehicle, namely its movement. More particularly, such an accessory is not involved in the implementation of the engine of the vehicle but is likely to control the latter. As an example, the equipment can be a dashboard, or even a speedometer.

Such an accessory commonly comprises a device for displaying at least one information item, such as an information item relating to the implementation of the accessory. In the case where the accessory is an installation of the abovementioned kind, said information item is, for example, a numerical datum, such as the temperature of the air contained in the passenger compartment and/or the desired temperature of said air, or even a pictogram- or icon-type symbol, of the kind representing the outline of the vehicle's passenger compartment. In the case where the accessory is a portable telephone, said information item is, for example, an information item of the telephone number and/or correspondent name kind. In the case where the accessory is an onboard computer or a satellite locating system, said information item is, for example, an alphanumeric character, an icon or a pictogram.

The display device comprises a means of displaying said information item. The display means is notably a display screen with transmissive lighting, reflective lighting and/or transflective lighting. For example, the display means is likely to be a liquid crystal display screen, commonly defined by the acronym “LCD”, a screen comprising an array of thin film transistors, commonly defined by the acronym “TFT”, a vacuum fluorescent screen, commonly defined by the acronym “VFD” or an organic light-emitting diode screen, commonly defined by the acronym “OLED”, or even a fixed symbol.

The display device also comprises a front face for either protecting the display means and/or serving as a surface for projecting said information item. The front face is, for example, a decorative pane designed to protect the display means from the environment outside the display device. The front face is likely to have an irregular and/or granular surface with bumps, notably in the case where it is not polished. The display means and the front face are arranged facing one another, with a space provided between them which is filled with air, the refractive index of which is equal to 1.

The display means is designed to make visible to a user said information item which is generated on the surface of the display means. In the case where the display means is an “LCD” type screen, said screen is associated with at least one light source designed to backlight it, in order to make said information item visible to the user through the front face. The display means is shaped into a flat surface which extends along a general extension plane.

A general problem that arises concerns the fact that the information item displayed on the display means is liable to generate an image projected onto the front face which is blurred for a user looking at said screen through the front face. In order to try to resolve this problem, the document US 2006/0139759 (HASHIMOTO et al) proposes arranging between the display means and the front face an imaging optical system which consists of a plurality of identical lenses divided up into two groups. The lenses of a first group are arranged along a first plane placed facing the screen, and the lenses of a second group are arranged along a second plane placed facing the front face, the second plane being parallel to the first plane. Each lens of the first group has an input face through which incoming light rays originating from the display means penetrate and each lens of the second group has an output face for light rays toward the front face, the incoming light rays passing through said system as far as the corresponding output fade to ultimately reach the front face.

Each lens has an optical axis and two vertices formed at a respective end of the optical axis of said lens. The optical axes of the lenses are oriented parallel to one another, while also being oriented orthogonally on the one hand to the general extension plane of the display means and on the other hand to the first and to the second planes. Moreover, each lens of the first group is placed directly in line with a corresponding lens of the second group. In other words, each lens of the first group is placed facing a corresponding lens of the second group, so that their respective optical axes are identical and that one of the vertices of the lens of the first group is in contact with one of the vertices of the corresponding lens of the second group.

Using a display device equipped with such an imaging optical system presents drawbacks which need to be remedied.

Firstly, in the case where the display device comprises a plurality of light sources, the image of said information item seen by the user through the front face is likely to consist of a plurality of partial images of said information item, which is particularly unsatisfactory for the user.

Furthermore, the viewing angle for a clear image for the user is likely to be restricted. More specifically, a user situated in a peripheral area of the display device cannot clearly view the information, which is restrictive, even dangerous for a user driving the vehicle.

Finally, one or more ghost images of said information item are likely to be projected onto the front face and/or close to the latter. These ghost images are a visual nuisance for the user that should preferably be minimized.

### OBJECT OF THE INVENTION

The aim of the present invention is to propose an optical system comprising a plurality of lenses divided up into at least one first group comprising at least two lenses and one second group comprising at least two lenses, at least one lens of the first group being arranged directly in line with a corresponding lens of the second group, said optical system being able to focus an image onto a front face of practically any conformation, without generating ghost images, said image being clear, precise and complete. Another aim of the present invention is to propose a display device comprising such an optical system, such a display device being designed to display an information item relating to the implementation of an automobile accessory and being effective, small and reliable so as to be able to deliver to a user said information item without the latter being distorted or corrupted and without distracting the user by creating visual artifacts.

The optical system of the present invention is an optical system comprising a plurality of lenses divided up into at least one first group comprising at least two lenses and one second group comprising at least two lenses. At least one lens of the first group is arranged directly in line with a corresponding lens of the second group.

According to the present invention, said optical system is equipped with means of channeling light rays entering into any lens of the first group toward the corresponding lens of the second group.

These arrangements are designed to prevent the passage of light rays entering into any lens of the first group toward a lens of the second group other than that arranged directly in line with said lens of the first group. The light rays entering into a lens of the first group are oriented by channeling means toward the corresponding lens of the second group placed directly in line with the lens of the first group, to avoid dispersion of these incoming light rays toward a lens of the second group other than that situated facing the lens concerned of the first group.

The result of this is that an image of said information item, projected onto a front face, is clear, precise and complete. Another result is an absence of ghost images projected onto said front face.

Said channeling means advantageously comprise a main grating which is interposed between the lenses of the first group and the lenses of the second group, the main grating comprising a distal edge bearing against the lenses of the first group and a proximal edge bearing against the lenses of the second group.

The main grating preferentially comprises a plurality of main channels which extend between the distal edge and the proximal edge of said main grating.

Each main channel is advantageously formed directly in line with a corresponding pair of lenses of the first group and of the second group arranged directly in line with one another.

Preferably, each main channel extends longitudinally between a first orifice which covers a lens of the first group and a second orifice which covers the corresponding lens of the second group.

The lenses of the first group are notably arranged along a surface S1 whereas the lenses of the second group are notably arranged along a surface S2.

The surface S1 is, for example, shaped in a first plane P1.

Each lens of the first group preferentially has a first optical axis A1 which is oriented orthogonally to said first plane P1 and in that each lens of the second group has a second optical axis A2 which is also oriented orthogonally to said first plane P1.

The first A1 and second A2 respective optical axes of lenses of the first group and of the second group of one and the same pair are notably identical.

Each main channel advantageously has an axis of symmetry A which is identical to the first A1 and second A2 optical axes.

The main grating is, for example, arranged on a grating plane P′ which is formed parallel to said first plane P1.

The main grating is notably produced from an optically opaque material.

Each main channel advantageously houses a lens of a third group which is identical to the lenses of the first and second groups.

Each lens of the third group preferentially has a third optical axis A3 which is identical to the first A1 and second A2 optical axes.

Each lens of the third group is preferably placed at an equal distance X from the lenses of the first and second groups between which the lens of the third group is interposed.

The lenses of the third group are advantageously arranged on a third plane P3 which is formed parallel to the first plane P1.

The channeling means preferentially comprise at least one secondary grating provided with secondary channels.

Each secondary channel advantageously houses a respective lens of the first group.

Each secondary channel preferably houses a respective lens of the second group.

Each lens of the first group is, for example, arranged directly in line with a respective pixel that the display means comprises.

The display device of the present invention is mainly recognizable by the fact that it is a device for displaying at least one information item comprising a display means, a front face and such an optical system, said display means generating said information item in the form of light rays and being arranged facing the front face, said optical system being interposed between the display means and the front face in order to project said information item onto the front face.

Said surface S1 has, for example, a conformation similar to a conformation C,P″ of the front face.

Said surface S1 also has, for example, a conformation symmetrical to a conformation C,P″ of the front face relative to a plane of symmetry interposed between the front face and the surface S1.

According to a first embodiment, the lenses of the first group are optically different from one another in order to focus an image of said information item on the front face.

According to a second embodiment, the lenses of the second group are optically different from one another in order to focus an image of said information item on the front face.

The front face is, for example, arranged along an incurved line C, the radius of curvature of which is either directed toward the interior of the display device or toward the exterior of the latter.

The first plane P1 is preferably provided parallel to a general extension plane P of the display means.

### DESCRIPTION OF THE FIGURES

The present invention will be better understood, and details emerging therefrom will become apparent, from reading the following description of variant embodiments in conjunction with the figures of the appended plates, in which:

FIG. 1 is a schematic illustration of an information display device according to the present invention.

FIG. 2 is a schematic illustration of a first variant embodiment of the device illustrated in the preceding figure.

FIG. 3 is a schematic illustration of a second variant embodiment of the device illustrated in FIG. 1.

FIG. 4 is a schematic illustration of a third variant embodiment of the device illustrated in FIG. 1.

FIG. 5 is a schematic illustration of a fourth variant embodiment of the device illustrated in FIG. 1.

FIG. 6 is a schematic illustration of a fifth variant embodiment of the device illustrated in FIG. 1.

FIG. 7 is a schematic illustration of a sixth variant embodiment of the device illustrated in FIG. 1.

FIG. 8 is a schematic illustration of a seventh variant embodiment of the device illustrated in FIG. 1.

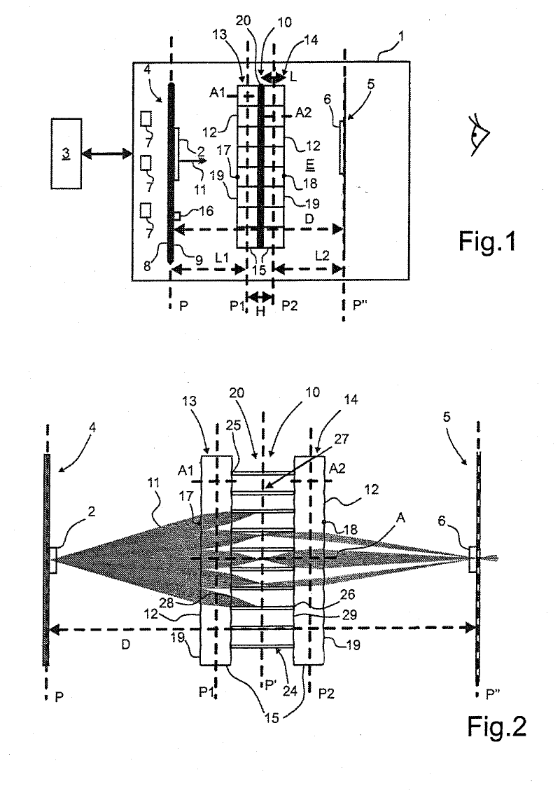

In FIG. 1, a device 1 for displaying an information item 2 relating to the implementation of an accessory 3 is designed to equip an automobile. The accessory 3 notably consists of a ventilation, heating and/or air conditioning installation but can, similarly, consist of a portable telephone, a satellite locating system, an onboard computer or any other appliance that is not essential to the primary function of the automobile, namely its movement. The display device 1 is designed to be arranged inside the vehicle's passenger compartment so as to deliver said information item 2 to a user of the vehicle. Said information item 2 is, for example, a numerical datum, such as the temperature of the air contained in the passenger compartment, or a pictogram schematically representing the vehicle. The display device 1 is likely to be an interactive device enabling the user to control implementation of the accessory 3. In this case, the display device 1 is, for example, organized as a tactile device equipped with the electronic elements needed for a controlled implementation of the accessory 3.

The display device 1 comprises a display means 4 for displaying the information item 2 and a front face 5 on which the user views an image 6 of said information item 2. The display means 4 is commonly a flat screen which is shaped on a general extension plane P. The display means 4 is a screen of almost any kind, for example of the “LCD”, “TFT”, “OLED”, “VFD” or similar type, and is likely to be equipped with several light sources 7, notably in the case where the screen is of the “LCD” or “TFT” type; the light sources 7 being arranged facing a rear face 8 of the display means 4, in order to allow the latter 4 to be backlit and then enable the information item 2 to be displayed.

Especially to protect the display means 4, the front face 5 is arranged facing a front panel 9 of the display means 4. Generally, the front face 5 covers the display means 4 in order to mask it when it is off, notably for esthetic reasons. Said front face 5 is arranged at a distance D from the display means 4, a space E being provided between the display means 4 and the front face 5. Moreover, notably for esthetic reasons, it is desirable for the front face 5 to be granular and have irregularities, such as bumps and/or pits.

An imaging optical system 10 is interposed between the display means 4 and the front face 5 in order to focus the image 6 of the information item 2 on the front face 5. In general, the imaging optical system 10 is a system of almost any kind able to make light rays 11 entering into the imaging optical system 10 converge at a point of the front face 5. Said imaging optical system 10 comprises at least a plurality of optical lenses 12 which are divided up into a first group 13 of lenses 12 and a second group 14 of lenses 12, a lens 12 of the first group 13 being arranged facing a lens 12 of the second group 14. Thus, the lenses 12 are arranged in pairs 15 of superposed lenses 12 formed by a lens 12 of the first group 13 and by a lens 12 of the second group 14. Each lens 12 of the first group 13 has an optical axis A1 which is oriented orthogonally to the general extension plane P of the display means 4 and each lens 12 of the second group 14 has a second optical axis A2 which is also oriented orthogonally to the general extension plane P of the display means 4. The optical axes A1 and A2 of a pair 15 of superposed lenses 12 of the first group 13 and of the second group 14 are identical.

The lenses 12 of the first group 13 are arranged on a first plane P1 which is formed parallel to the general extension plane P of the display means 4. The lenses 12 of the first group 13 are, for example, arranged directly in line with a respective pixel 16 that the display means 4 comprises. However, the lenses 12 of the first group 13 are likely to be arranged differently relative to the pixels 16 that the display means 4 comprises. It will be understood that, in the plane P1, the lenses 12 of the first group 13 are likely to be arranged relative to one another in almost any mosaic pattern, preferentially hexagonal, or even square or rectangular, in an order from the most optically effective to the least effective.

Each lens 12 has an input face 17 through which the incoming light rays 11 penetrate and an output face 18 through which light rays leave the lens 12. The input face 17 and the output face 18 have a respective vertex defined as a point of the surface of the lens 12 through which the optical axis A1, A2 of the lens 12 passes. Said lens 12 has a thickness L defined as the distance between the two vertices 19 of the lens 12.

Moreover, each lens 12 of the first group 13 is situated at a distance L1 from the display means 4 whereas each lens 12 of the second group 14 is situated at a distance L2 from the projection surface 5. Finally, a lens 12 of the first group 13 is placed at a distance H from the lens 12 of the second group 14 with which it constitutes the pair 15 of superposed lenses 12.

The lenses 12 of the first 13 and of the second 14 groups are either produced from glass by a photolithographic process or a machining process, or from a plastic material based on an injection or press molding method.

Such an imaging optical system 10 has the drawback of delivering to the user an image 6 of the information item 2 which is blurred and/or truncated. Furthermore, ghost images of the desired image of the information item 2 appear on and/or close to the front face 5. Finally, such an imaging optical system 10 is not suitable for a front face 5 of almost any conformation.

This is why it is advantageously proposed by the present invention to equip the imaging optical system 10 with means 20 of channeling incoming light rays 11 within any lens 12 of the first group 13 toward the corresponding lens 12 of the second group 14 with which said lens 12 of the first group 13 forms a pair 15 of lenses 12 facing one another, that is to say, the lens 12 of the second group 14 whose second optical axis A2 is identical to the first optical axis A1 of the lens 12 concerned of the first group 13.

These arrangements mean that the imaging optical system 10 is able to deliver to the user a clear and precise image 6, regardless of the shape and size of the information item 2. These arrangements are also intended to provide a uniform and complete view of the image 6 for the user.

According to a first, a second and a third variant embodiment of the present invention respectively represented in FIGS. 2 to 4, the channeling means 10 comprise a main grating 24 which is interposed between the lenses 12 of the first group 13 and the lenses 12 of the second group 14 by bearing against one another. More specifically, the main grating 24 extends along a grating plane P′ parallel to the general extension plane P of the display means 4. On either side of the plane P′, the main grating 24 comprises a distal edge 25 which is bearing against the lenses 12 of the first group 13 and a proximal edge 26 which is bearing against the lenses 12 of the second group 14. According to these variants, the distal 25 and proximal 26 edges are flat and parallel.

The main grating 24 is provided with main channels 27 which pass through it from end to end from the distal edge 25 to the proximal edge 26 of said main grating 24. The main channels 27 are parallel to one another and extend longitudinally along an axis of symmetry A which is identical to the first A1 and second A2 optical axes of the lenses 12 of the first 13 and second 14 groups of the pair 15 of corresponding lenses 12.

Each main channel 27 is formed directly in line with a corresponding pair 15 of lenses 12 of the first 13 and of the second 14 groups. More specifically, each main channel 27 is longitudinally delimited by a first orifice 28 which covers a lens 12 of the first group 13 and a second orifice 29 which covers the corresponding lens 12 of the second group 14.

The main grating 24 is produced from an optically opaque material, such that light rays penetrating into a main channel 27 via the first orifice 28 can leave said main channel 27 only via the second orifice 29 of the main channel concerned 27.

These arrangements are such that, based on a covering of the output face 18 of the lenses 12 of the first group 13 and of the input face 17 of the lenses 12 of the second group 14, the incoming light rays 11 within a lens 12 of the first group 13 can be propagated only toward the corresponding lens 12 of the second group 14 with which it forms a pair 15 of superposed lenses 12. Thus, the information item 2 displayed on the display means 4 is reproduced identically on the front face 5 without the appearance of ghost images.

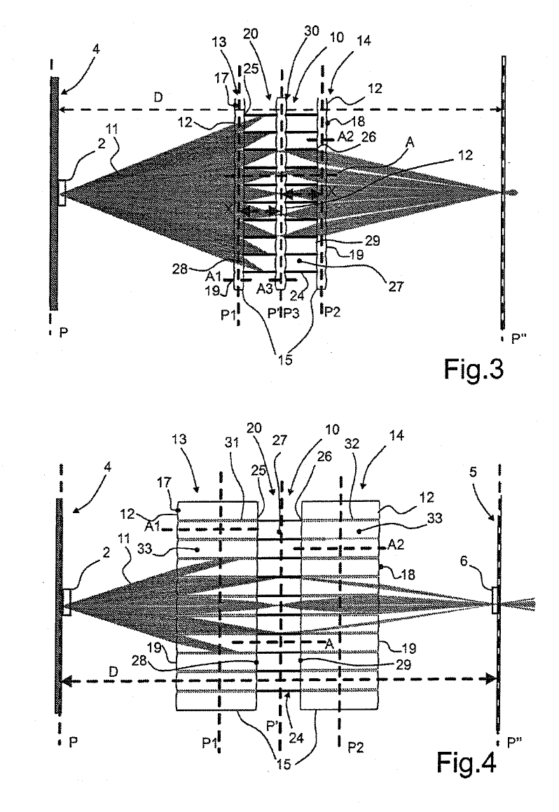

More particularly in FIG. 3, each main channel 27 of the main grating 24 houses a lens 12 of a third group 30 which lenses have a pitch that is identical to the lenses 12 of the first 13 and second 14 groups, and which are convergent. The lenses 12 of the third group are arranged on a third plane P3 which is formed parallel to the first plane P1. Preferentially, the lenses 12 of the third group 30 are identical to the lenses 12 of the first 13 and second 14 groups.

Each lens 12 of the third group 30 has a third optical axis A3 which is identical to the first A1 and second A2 optical axes. Each lens 12 of the third group 30 is placed at an equal distance X from the lenses 12 of the first 13 and second 14 groups between which the lens 12 of the third group 30 is interposed.

According to the variant embodiment represented in FIG. 4, the channeling means 10 comprise, in addition to the main grating 24, two secondary gratings 31, 32 each provided with secondary channels 33. Each secondary channel 33 of a first secondary grating 31 houses a respective lens 12 of the first group 13 whereas each secondary channel 33 of a second secondary grating 32 houses a respective lens 12 of the second group 14. According to one embodiment that is not represented, the channeling means 10 can also comprise, in addition to the main grating 24, exclusively one 31 or the other 32 of the secondary gratings 31, 32. The secondary gratings 31, 32 are more particularly necessary if the thickness L of the lenses 12 is no longer very much less than the distance H, notably when the ratio H/L is of the order of 3 or less.

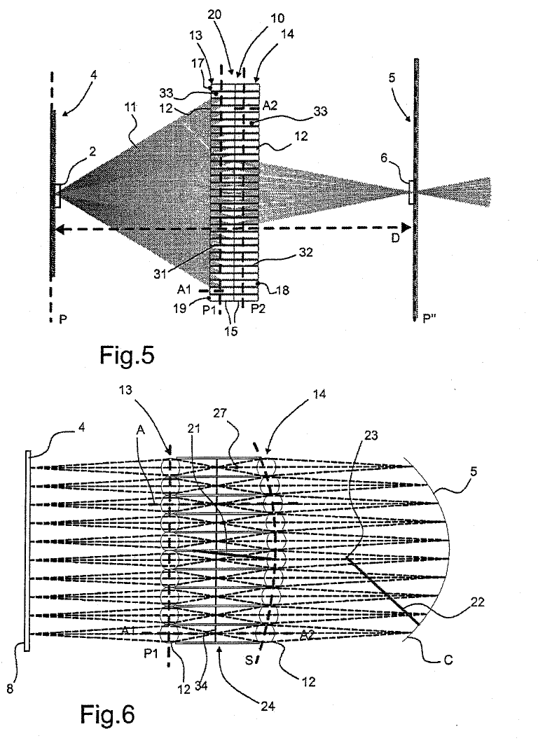

According to a fourth variant embodiment illustrated in FIG. 5, the channeling means 10 solely consist of two secondary gratings 31, 32 as defined hereinabove. This variant is particularly suited to the case where the two groups 13, 14 of lenses 12 are virtually touching.

It will be noted that, according to the first, second, third and fourth variant embodiments respectively illustrated in FIGS. 2 to 5, the lenses 12 of the second group 14 are arranged on a second plane P2 which is formed parallel to said first plane P1 and to a plane P″ with the general conformation of the front face 5.

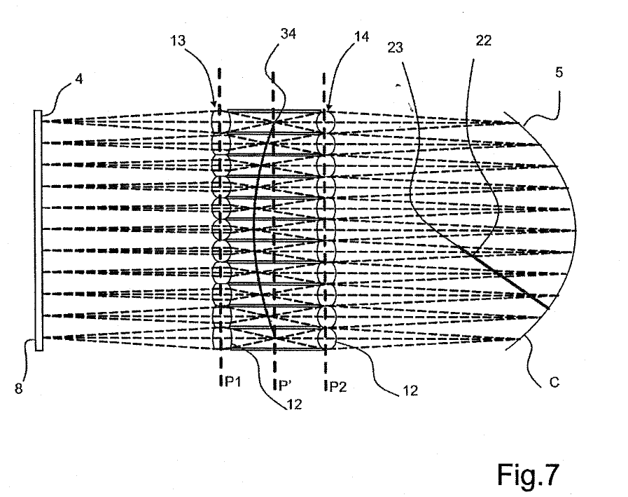

According to a fifth and a sixth variant embodiment respectively illustrated in FIGS. 6 and 7, the front face 5 is arranged along a curve C whose radius of curvature 22 is directed toward the display means 4 and whose center of curvature 23 is either situated between the display means 4 and the projection front face 5 or arranged facing the rear panel 8 of the display means 4. According to another embodiment, the radius of curvature is oriented toward the outside of said display device.

More particularly according to the fifth variant embodiment illustrated in FIG. 6, the lenses 12 of the second group 14 are arranged on an incurved surface S2 that has a radius of curvature 21 directed toward the display means 4. The distribution of the lenses 12 of the second group 14 is similar to the conformation of the front face 5, each pair 15 of lenses 12 providing an enlargement equal to 1. In this case, an intermediate image 34 of the information item 2 via the lenses of the first group 13 is flat.

It will be noted at this point in the description that, according to the variants illustrated previously, the lenses 12, either of the first group 13 or of the second group 14, are identical to one another. On the other hand, according to the sixth variant embodiment illustrated in FIG. 7, the lenses 12 of the second group 14 are adapted so as to make said intermediate image 34 projected onto the front face 5 curved. For this, the lenses 12 of the second group 14 are different from one another, from a pair 15 of lenses 12 of the first 13 and second 14 groups, so that each pair 15 of lenses 12 works with an enlargement equal to 1.

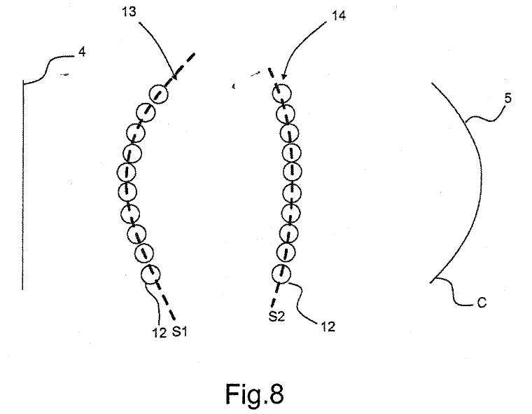

According to a seventh variant embodiment illustrated in FIG. 8, the lenses 12 of the first group 13 are arranged on a curved surface S1, in which case the curvature of the latter S1 is inverted relative to the case in which only the lenses 12 of the second group 14 are arranged on the surface S2. It is also possible to consider simultaneously arranging the lenses 12 of the first group 13 on an incurved surface Si and the lenses 12 of the second group 14 on an incurved surface S2, in which case the curvature of the surface S2 has the same conformation, but less accentuated, that the curvature of the front face 5 whereas the curvature of the surface S1 has an opposite but more accentuated conformation than that of the front face 5. The effect of the curvatures of the surfaces S1 and S2 is added together in order to match to the curvature of the front face 5. The curvatures of the surfaces S1 and S2 satisfy a rule that recommends that all the pairs 15 of lenses 12 provide an enlargement of 1.

1. An optical system comprising:
a plurality of lenses divided up into at least a first group comprising at least two lenses and a second group comprising at least two lenses,
wherein at least one lens of the first group is arranged directly in line with a corresponding lens of the second group,
wherein the optical system is equipped with means of channeling light rays entering into the at least one lens of the first group toward the corresponding lens of the second group.

2. The optical system as claimed in claim 1, wherein the channeling means comprise a main grating which is interposed between the lenses of the first group and the lenses of the second group, the main grating comprising a distal edge bearing against the lenses of the first group and a proximal edge bearing against the lenses of the second group.

3. The optical system as claimed in claim 2, wherein the main grating comprises a plurality of main channels which extend between the distal edge and the proximal edge of the main grating.

4. The optical system as claimed in claim 3, wherein each main channel is formed directly in line with a corresponding pair of lenses of the first group and of the second group, the corresponding pair of lenses arranged directly in line with one another.

5. The optical system as claimed in claim 3, wherein each main channel extends longitudinally between a first orifice which covers the at least one lens of the first group and a second orifice which covers the corresponding lens of the second group.

6. The optical system claimed in claim 1, wherein the lenses of the first group are arranged along a first surface, and the lenses of the second group are arranged along a second surface.

7. The optical system as claimed in claim 6, wherein the first surface is shaped in a first plane.

8. The optical system as claimed in claim 7, wherein each lens of the first group has a first optical axis which is oriented orthogonally to said first plane, and wherein each lens of the second group has a second optical axis which is also oriented orthogonally to said first plane.

9. The optical system as claimed in claim 8, wherein the first and second respective optical axes of paired lenses of the first group and of the second group are identical.

10. The optical system as claimed in claim 2, wherein the main grating is produced from an optically opaque material.

11. The optical system as claimed in claim 3, wherein each main channel houses a lens of a third group which is a convergent lens having a same pitch as the lenses of the first and second groups.

12. The optical system as claimed in claim 1, wherein the channeling means comprise at least one secondary grating provided with secondary channels.

13. The optical system as claimed in claim 12, wherein each secondary channel houses a respective lens of the first group.

14. The optical system as claimed in claim 12, wherein each secondary channel houses a respective lens of the second group.

15. The optical system as claimed in claim 7, wherein the lenses of the second group are arranged along a second plane which is provided parallel to said first plane.

16. A device for displaying at least one information item, said device comprising:
a display means;
a front face; and
an optical system comprising:
a plurality of lenses divided up into at least a first group comprising at least two lenses and a second group comprising at least two lenses,
wherein at least one lens of the first group is arranged directly in line with a corresponding lens of the second group,
wherein the optical system is equipped with means of channeling light rays entering into the at least one lens of the first group toward the corresponding lens of the second group,
said display means generating said information item in the form of the light rays and arranged facing the front face, said optical system being interposed between the display means and the front face in order to project said information item onto the front face.

17. The display device as claimed in claim 16, wherein the lenses of the first group are arranged along a first surface, and the lenses of the second group are arranged along a second surface, wherein said first surface has a conformation similar to a conformation of the front face.

18. The display device as claimed in claim 16, wherein the lenses of the first group are arranged along a first surface, and the lenses of the second group are arranged along a second surface, wherein said first surface has a conformation symmetrical to a conformation of the front face relative to a plane of symmetry interposed between the front face and the first surface.

19. The display device as claimed in claim 16, wherein the lenses of the first group are optically different from one another in order to focus an image of said information item on the front face.

20. The display device as claimed in claim 16, wherein the lenses of the second group are optically different from one another in order to focus an image of said information item on the front face.

21. The display device as claimed in claim 16, comprising an optical system, comprising:
a plurality of lenses divided up into at least a first group comprising at least two lenses and a second group comprising at least two lenses,
wherein at least one lens of the first group is arranged directly in line with a corresponding lens of the second group,
wherein the optical system is equipped with means of channeling light rays entering into the at least one lens of the first group toward the corresponding lens of the second group,
wherein the first surface is shaped in a first plane and wherein the first plane is provided parallel to a general extension plane of the display means.
